(19) United States
(12) Patent Application Publication
(10) Pub. No.: US 2023/0234634 A1
(43) Pub. Date: Jul. 27, 2023

(54) STEERING COLUMN FOR A MOTOR VEHICLE

(71) Applicants: thyssenkrupp Presta AG, Eschen (LI); thyssenkrupp AG, Essen (DE)

(72) Inventors: Andreas BACHMANN, Langenargen (DE); Konstantin SCHWARZKOPF, Diepoldsau (CH); Thomas Werner HEITZ, Mauren (LI)

(73) Assignees: thyssenkrupp Presta AG, Eschen (LI); thyssenkrupp AG, Essen (DE)

(21) Appl. No.: 18/099,587

(22) Filed: Jan. 20, 2023

(30) Foreign Application Priority Data
Jan. 21, 2022 (DE) 10 2022 200 667.4

(51) Int. Cl. B62D 5/00; B62D 6/00

(52) U.S. Cl. CPC B62D 5/006; B62D 6/008

(57) ABSTRACT

A steering column for a motor vehicle may include a steering shaft mounted in a casing unit so as to be rotatable about a longitudinal axis, and a feedback actuator that has an electric motor with a motor shaft that is aligned axially along a motor axis, arranged at a distance parallel to the longitudinal axis, and coupled to the steering shaft via a transmission. The motor is connected to a control unit for electrical operation. The control unit may be integrated with the feedback actuator. And the transmission may be arranged axially between the motor and the control unit.

### CROSS REFERENCE TO RELATED APPLICATION

This application is a U.S. Non-Provisional that claims priority to German Patent Application No. DE 10 2022 200 667.4, filed Jan. 21, 2022, the entire contents of which are incorporated herein by reference.

### FIELD

The present disclosure generally relates to steering columns, including steering columns for motor vehicles that include feedback actuators.

### BACKGROUND

Steer-by-wire steering systems for motor vehicles, like conventional mechanical steering systems, accept manual steering commands from the driver by the turning of a steering wheel of an input unit that is attached to the driver's end of a steering shaft, at the rear in the direction of travel. However, the steering shaft is not mechanically connected via a steering gear to the wheels to be steered, but acts in combination with angle-of-rotation, or torque, sensors that sense the input steering command and transmit an electrical control signal determined therefrom to a steering adjuster that sets a corresponding steering angle of the wheels by means of an electric positioning drive.

In the case of steer-by-wire steering systems, the driver receives no direct mechanical feedback from the steered wheels via the steering train, which in the case of conventional mechanically coupled steering systems is fed back to the steering wheel, via the steering gear and the mechanically continuous steering shaft, as a reaction moment, or restoring moment, in dependence on the road surface, the vehicle speed, the current steering angle and other operating conditions. The lack of haptic feedback makes it difficult for the driver to reliably sense current driving situations and perform appropriate steering manoeuvres, which impairs the steerability of the vehicle, and thus driving safety.

In order to create a realistic driving experience, it is known in the prior art to sense parameters such as vehicle speed, steering angle, steering reaction moment and the like from an actual real-time driving situation, or to calculate them in a simulation, and from these to form a feedback signal that is fed into a feedback actuator. The feedback actuator has an electric control unit and, connected to it, an electric motor, the motor shaft of which is coupled to the steering shaft via a transmission. During driving, the motor is electrically operated by the control unit in order to couple a restoring moment (feedback moment), corresponding to the real reaction moment, into the steering wheel via the steering shaft. Such “force-feedback” systems give the driver the impression of a real driving situation as with conventional steering, which facilitates an intuitive reaction.

A generic steering column of the type mentioned above is known from DE 603 03 081 T2. The motor of the feedback actuator is attached to the casing unit laterally with respect to the longitudinal axis. The motor shaft is coupled to the steering shaft via a transmission. The control unit is realized separately, and may be attached to the steering column. The disadvantage of this design is the large amount of installation space required and the difficulty in mounting.

It has also been proposed, in a non-generic configuration, to integrate the motor of the feedback actuator, with its motor shaft coaxial with the longitudinal axis, within the casing unit. However, this limits the installation space of the feedback actuator due to the casing unit, and both the constructional adaptation and the production and mounting are more complex than in the generic design.

Thus a need exists for a more compact design and easier production and mounting.

### BRIEF DESCRIPTION OF THE FIGURES

FIG. 1 is a schematic view of an example steer-by-wire-steering system.

FIG. 2 is a schematic, perspective view of an example feedback actuator.

FIG. 3 is a schematic, perspective view of part of the feedback actuator according to FIG. 2.

FIG. 4 is a perspective view of the feedback actuator as in FIG. 3.

FIG. 5 is a schematic, perspective view of the feedback actuator according to FIGS. 2 to 4 with an actuator housing.

FIG. 6 is a side view transverse to a longitudinal axis of the feedback actuator according to FIG. 5.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure generally relates to steering columns for motor vehicles. In one example, a steering column may comprise a steering shaft mounted in a casing unit so as to be rotatable about a longitudinal axis, and a feedback actuator, which has an electric motor comprising a motor shaft that is aligned axially along a motor axis, arranged at a distance parallel to the longitudinal axis and coupled to the steering shaft via a transmission, the motor being connected to a control unit for the purpose of electrical operation. The control unit may be integrated with the feedback actuator, the transmission being arranged axially between the motor and the control unit.

It should be understood that the directional indications used herein to identify the position and arrangement of the individual functional elements relate throughout to the installation position of the steering column in the direction of travel of the vehicle, with the front or lower end on the body side facing forwards in the direction of travel and, correspondingly, the rear or upper end facing rearwards contrary to the direction of travel, towards the driver's position in the vehicle interior.

A manual steering handle, for example a steering wheel, can be attached to the rear axial end of the steering shaft.

The motor axis is arranged parallel to the longitudinal axis, in which case a solid angle of the axes relative to each other of up to 10° may also be understood as parallel in the sense of the invention. According to the invention, the electric control unit, which has electrical components for operating the motor, is realized, together with the motor and the transmission, as an integrated unit. The transmission in this case is attached in front of the motor, as viewed from the motor, and the control unit is attached in front of the transmission, i.e. in the front region of the feedback actuator that is remote from the motor. This feedback actuator unit can be compactly designed as an entity, and can be mounted with little difficulty on the outside of the casing unit during production, such that only an electrical connection of the feedback actuator to the vehicle electrical system is required. It is thus possible to achieve a reduced effort in production and mounting, and the installation space requirement can be kept small due to the integrated design.

Another advantage is that the structural size and configuration of the feedback actuator is not limited by the dimensions of the casing unit, thereby allowing greater constructional freedom.

Moreover, it is possible with relatively little effort to use different configurations of feedback actuators that are adapted in respect of their performance or other characteristics. This simplifies the construction and makes the production of different types of steering columns more flexible than, for example, in the case of the feedback actuator being arranged inside the casing unit.

It may be provided that the control unit is arranged, on a front side, in front of a front end of the motor shaft. Preferably, the control unit may also be arranged in front of a front end of the steering shaft. The transmission in this case is preferably integrated between a front end portion of the motor shaft and a front end portion of the steering shaft. It may be realized as a belt drive, having a belt wheel coupled to the motor shaft, and a belt wheel attached in a rotationally fixed manner to the steering shaft, and a revolving drive belt, which may be realized as a toothed belt, V-belt or flat belt. Such a belt drive is smooth-running and light. Alternatively or additionally, the transmission may comprise gearwheels. According to the invention, the control unit is positioned in front of the front-side axial end faces of the transmission shafts. It is possible in this case for the control unit not to project over the transmission. This arrangement has the advantage that a compact design is possible.

An advantageous embodiment is that the feedback actuator has an actuator housing attached to the outside of the casing unit. The transmission and the control unit are preferably housed in the actuator housing. The motor arranged outside the casing unit may be attached to the actuator housing, or may also be integrated in the actuator housing. The control unit, including the electrical connection to the motor, may be housed in the actuator housing, protected against external mechanical and electrical influences. A robust and compact embodiment can thus be achieved.

It may preferably be provided that the control unit is arranged axially in the actuator housing with respect to the motor shaft. According to the invention, the transmission is arranged in front of the motor, axially between the motor and the control unit with respect to the motor shaft, and the control unit is arranged on the front side of the transmission that is remote from the motor. This allows the control unit to be arranged in a structurally simple and protected manner, separate from the mechanically moving parts of the motor and transmission.

It may be advantageous for the actuator housing to have a control housing. The control housing may preferably be attached to the actuator housing at the front, on the front side that faces away from the transmission, and may thus form a front-side front closure of the actuator housing. The control unit may be housed in the control housing. The control housing may be realized, for example, in the form of a hood or cap, and may be attachable to the actuator housing in such a manner that it can at least partially encompass the control unit, or preferably completely enclose it together with walls of the actuator housing. A cover may also be provided, which covers towards the front a housing interior of the actuator housing or control housing that houses the control unit. According to the invention, the control unit in this case is arranged axially between the control housing and the transmission. The connection between the actuator housing and the control housing is preferably sealed, such that an arrangement that is well protected against moisture, dust and other potential external harmful influences can be realized. The seal may be realized as cord seal, or as an elastomer seal moulded onto one of the housing components.

The control housing may preferably be detachably connected to the actuator housing, for example by means of detachable connection elements such as screws or the like. This provides for simplicity of production and mounting. In an advantageous further development, it may be provided that the screws are realized as breakaway screws or as screws that have a non-standard drive, such that demounting by non-expert persons is avoided or at least made more difficult.

It is possible for the actuator housing to have a transmission housing. The transmission housing may be attached axially at the rear of the actuator housing. Thus, it is arranged on the rear side that faces away from the control unit and faces towards the motor. Gearwheels of the transmission may be mounted in the transmission housing. The motor may be attached, for example flange-mounted, to the control housing. The transmission housing may be realized separately and connected to the actuator housing, or at least partially integrated with the actuator housing. It is thus possible to realize a space-saving embodiment that is easily mounted and produced.

The transmission housing may be positioned axially between a control housing and the motor. This arrangement has the advantage that the control unit and the transmission are each easily accessible independently of each other and are protected against external influences.

The transmission housing may preferably be detachably connected to the actuator housing, for example by means of detachable connection elements such as screws or the like. This provides for simplicity of production and mounting. The connection may preferably be sealed, such that the transmission is protected against external harmful influences such as moisture, dust and the like.

It is advantageous for the actuator housing to have connection elements that can be connected to the casing unit. This enables the feedback actuator to be fastened to the steering column, which may have corresponding connection elements, in a simple, easily mountable manner.

An advantageous embodiment may provide that the control unit has a printed circuit board having a planar extent. The printed circuit board constitutes a printed board on which electrical components of the control unit are mechanically fastened and electrically interconnected via conducting tracks. The printed circuit board may preferably be arranged with its planar extent transverse (normal) to the motor axis and longitudinal axis. According to the invention, the printed circuit board may preferably be arranged, on a front side, in front of the motor shaft and the steering shaft. An advantage is that the printed circuit board can be easily adapted, in respect of its shape and dimensions, in order for it to be housed, for example, in a control housing. The electrical connectors required for terminating to the motor and the vehicle electrical system may also be attached to the printed circuit board, such that a modular, easily mounted control unit can be provided.

It is advantageous for the control unit to be connected to the motor via control lines extending in the axial direction through the transmission. The control lines bridge the transmission in the axial direction, which is positioned between the control unit arranged at the front and the motor attached at the rear. One advantage of this is that the control lines can be housed in the actuator housing, protected against harmful mechanical and electrical influences.

It may preferably be provided that connection lines of the control unit that can be connected to the control unit are routed out of the feedback actuator towards the front. The connection lines serve to electrically connect the feedback actuator to the vehicle electrical system, and include electric power supply leads and control lines. For example, the connection lines may be routed out of the actuator housing through a frontally attached, front-side cover or a control housing to the outside. There they may be connected, for example via a plug-and-socket connection, to an on-board electronics system of the motor vehicle. An advantage of this arrangement is that the connection can be effected entirely in a front region where the steering column is held on the vehicle body, and electrical connection cables can be routed easily and out of the passenger compartment of the vehicle.

It may be advantageous for the control unit to have at least one sensor element interacting with the steering shaft and/or the motor shaft. The sensor element may comprise, for example, an electronic rotary sensor for sensing a rotation or angular position of the steering shaft and/or the motor shaft. This enables measurement of the rotational movements generated by the feedback actuator, and electronic closed-loop control of the feedback torque generated may be effected. In addition, by comparison of the rotations of the steering shaft and motor shaft, functioning can be monitored, for example as to whether there is slippage occurring in the transmission or the torque transmission is being otherwise disrupted. The functional and operational safety can thus be increased. The arrangement according to the invention enables the sensor element or elements to be positioned in the front region of the steering shaft and/or motor shaft in a functionally reliable and easily mountable manner.

One or more sensor elements may be arranged, for example, on a printed circuit board of the control unit. This provides for simplicity of production and a compact design.

The directional indications relate to the regular direction of travel of a vehicle, which is not represented in detail, the direction to the front being indicated in the figures by an arrow as direction V, and correspondingly the opposite direction H to the rear.

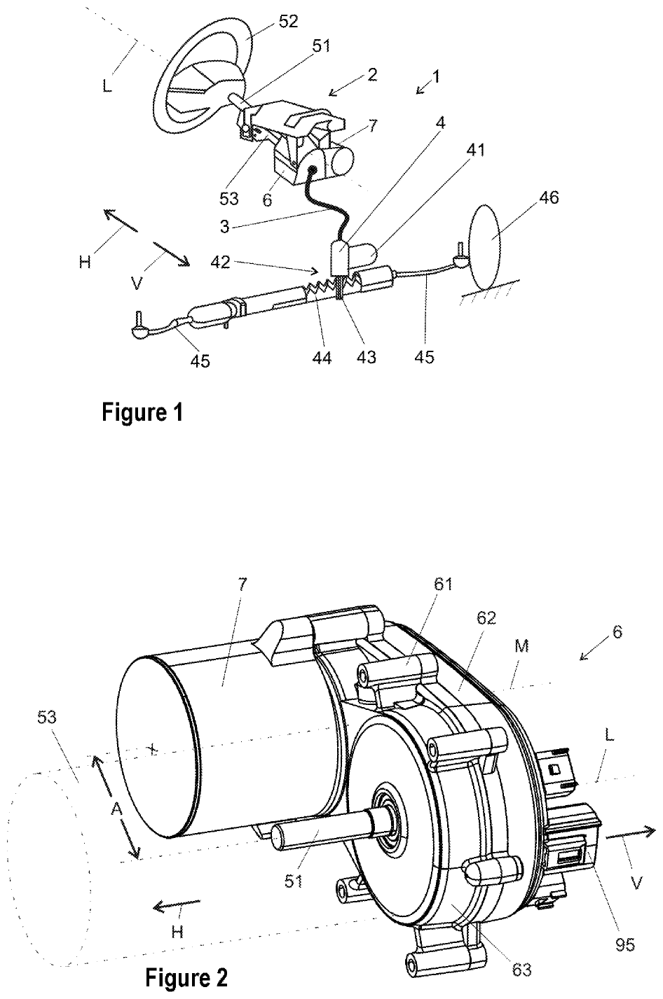

Shown schematically in FIG. 1 is a steer-by-wire steering system 1 comprising, as an input unit, a steering column 2 that is connected to an electric steering drive 4 via an electric lead 3.

The steering drive 4 comprises a positioning motor 41, which is connected to the electric connection line 3 and which introduces a steering positioning moment into a steering gear 42. There, the steering positioning moment is converted, via a pinion 43 and a toothed rack 44, into a translational movement of track rods 45, as a result of which a steering angle of the steered wheels 46 is effected, in a manner known per se, by pivoting of steering knuckles. Alternatively, the steered wheels 46 may be connected to individually operable electric positioning drives in order to realise individual wheel steering.

The input unit 2 has a steering shaft 51, to the rear end of which a steering wheel 52 is attached, and which is mounted in a casing unit 53 so as to be rotatable about a longitudinal axis L directed from the rear to the front.

The steering column 2 has a feedback actuator 6, which is represented in different views on the casing unit 53 in FIGS. 2, 3, 4, 5 and 6. FIG. 2 shows an exposed general view of the feedback actuator 6, which is attached to the casing unit 31 (indicated by a dashed line).

The feedback actuator 6 has an actuator housing 61, attached to the front side of which there is a hood-shaped control housing 62.

Attached to the rear of the actuator housing 61 there is a transmission housing 63.

The housings 61, 62 and 63 may be flange-connected to one another, for example by means of connecting bolts, the dividing plane between the housings 61 and 62, or 61 and 63, in each case being transverse to the longitudinal axis L.

An electric motor 7 is attached to the actuator housing 61 from the rear, for example flange-connected to the transmission housing 63 as in the example shown.

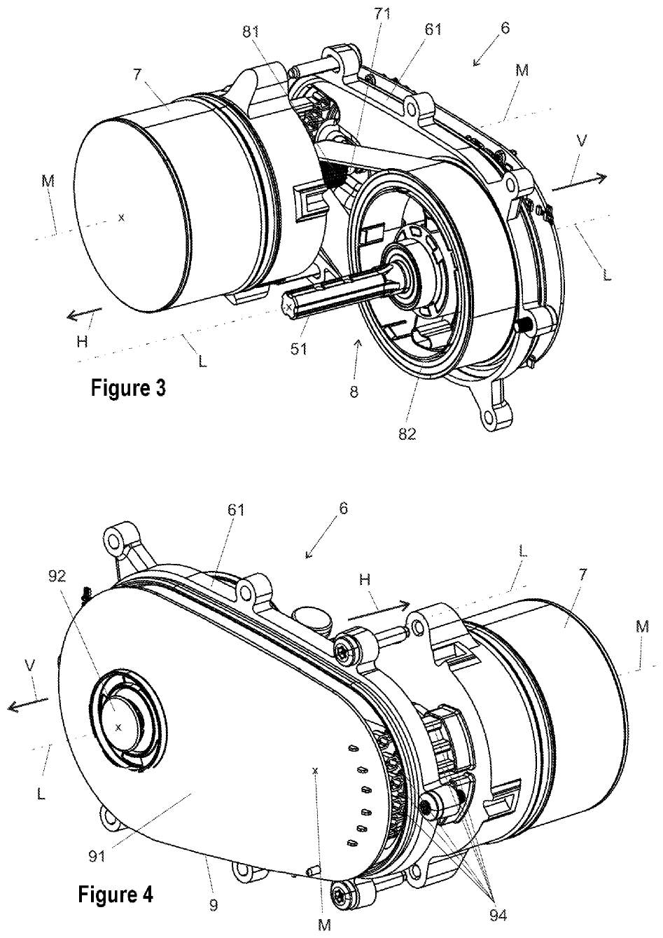

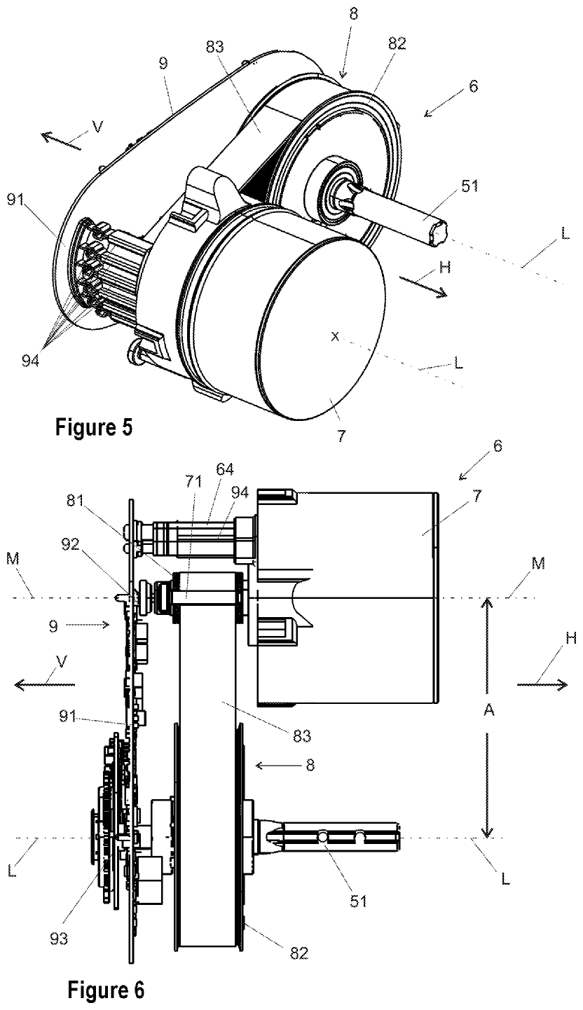

The motor 7 has a motor shaft 71 that extends along a motor axis M, as can be seen in FIGS. 6 and 3, in which the control housing 62 and the gear housing 63 are omitted for clarity. In contrast to FIGS. 3 and 4, inn FIGS. 5 and 6 the entire actuator housing 61 is additionally omitted so that the arrangement of the rest of the functional parts can be seen.

The longitudinal axis L and the motor axis M are parallel to each other and are spaced apart by a distance A. This distance A may preferably be at least as great as half the diameter, i.e. the radius of the casing unit 53.

Arranged in the transmission housing 63 there is a transmission 8, which in the example shown is realized as a belt transmission or toothed-belt transmission. This comprises a drive-side belt wheel 81 fixed on the motor shaft, a driven-side belt wheel 82 fixed on the steering shaft 51, and a belt 83 revolving around the belt wheels 81 and 82.

Arranged in the control housing 62 there is a control unit 9. This comprises a printed circuit board 91, having a planar extent transverse to the axes L and M, on which a plurality of electronic components are arranged and electrically connected to each other via conducting tracks.

It can be clearly seen from FIG. 6 that the circuit board is arranged, at the front, in front of the transmission 8. In other words, the transmission 8 is arranged, axially in relation to the longitudinal axis L or the motor axis M, between the control unit 9 and the motor 7.

The shape and dimensions of the printed circuit board 91 are adapted in such a manner to the interior of the control housing 62 that, when in the assembled state as in FIG. 2, it is fully received in the actuator housing 61 and sealed with respect to the exterior. Preferably in this case, the interior of the control housing 82 is also separated from and sealed with respect to the transmission housing 63.

An electronic rotary sensor 92 may preferably be arranged on the front axial front side of the motor shaft 71 and of the circuit board 91, for example comprising a Hall sensor, an optical incremental encoder or the like. This can be used to sense a rotational movement and/or an angular position of the motor shaft 71.

Similarly, an electronic rotary sensor 92 may preferably be arranged on the front axial end of the steering shaft 51 and of the circuit board 91, likewise comprising, for example, a Hall sensor, an optical incremental encoder or the like. This can be used to sense a rotational movement and/or an angular position of the motor shaft 71.

Control lines 94, which serve to operate the motor 7 through the control unit 9 and bridge the transmission 8 in the axial direction, may be arranged between the circuit board 91 and the motor 7. The control lines 94 may be arranged in a protected manner inside the actuator housing 61, as represented in FIG. 4, for example.

The circuit board 91 may be connected to an electrical connector 95 that has connection lines electrically connected to the circuit board and, for example, a socket attached to the outside of the control housing 62. A corresponding connector on a lead of the vehicle electrical system may be easily connected to the connector 95 in order to electrically couple the control unit 9 to the vehicle.

A particular advantage of the arrangement according to the invention is that, for the purpose of mounting, with the transmission 8 already mounted the circuit board 91 of the control unit 9 can simply be inserted axially from the front into the actuator housing 61 and fixed to a holding element 64 (see FIG. 6), for example by screw fastening, riveting or the like. In this way, the rotary sensors 92 and 93 can be assembled ready for operation without additional adjustment and without the need for additional connecting leads as in the prior art.

The control unit 9 is housed in a protected manner in the subsequently attached and fixed control housing 62.

### LIST OF REFERENCES

1 steering system

2 input unit

21 longitudinal axis

3 lead

4 steering drive

41 positioning motor

42 steering gear

43 pinion

44 toothed rack

45 track rod

46 wheel

5 feedback actuator

51 steering shaft

52 steering wheel

53 casing unit

6 feedback actuator

61 actuator housing

62 control housing

63 transmission housing

64 holding element

7 motor

71 motor shaft

8 transmission

81, 82 belt wheel

83 belt

9 control unit

91 printed circuit board

92, 93 rotary sensor

94 control line

95 connector (connection lines)

L longitudinal axis

M motor axis

A distance

V direction forwards

H direction rearwards

What is claimed is:

1. A steering column for a motor vehicle, comprising:
a steering shaft mounted in a casing unit so as to be rotatable about a longitudinal axis;
a feedback actuator that has an electric motor comprising a motor shaft that is aligned axially along a motor axis, arranged at a distance parallel to the longitudinal axis, and coupled to the steering shaft via a transmission; and
a control unit, wherein the motor is connected to the control unit for electrical operation, wherein the control unit is integrated with the feedback actuator,
wherein the transmission is disposed axially between the motor and the control unit.

2. The steering column of claim 1 wherein the control unit is arranged, on a front side, in front of a front end of the motor shaft.

3. The steering column of claim 1 wherein the feedback actuator has an actuator housing that is attached to an outside of the casing unit.

4. The steering column of claim 3 wherein the control unit is arranged axially in the actuator housing with respect to the motor shaft.

5. The steering column of claim 3 wherein the actuator housing has a control housing.

6. The steering column of claim 3 wherein the actuator housing has a transmission housing.

7. The steering column of claim 3 wherein the actuator housing has connection elements that are sized and shaped for connection to the casing unit.

8. The steering column of claim 1 wherein the control unit includes a printed circuit board that has a planar extent.

9. The steering column of claim 1 wherein the control unit is connected to the motor via control lines extending in an axial direction through the transmission.

10. The steering column of claim 1 wherein connection lines of the control unit that are sized and shaped for connection to the control unit are routed out of the feedback actuator towards a front.

11. The steering column of claim 1 wherein the control unit has a sensor element that interacts with the steering shaft and/or the motor shaft.
